(19) United States
(12) Patent Application Publication
(10) Pub. No.: US 2015/0262257 A1
(43) Pub. Date: Sep. 17, 2015

(54) Marketing Strategy Lifecycle Management

(71) Applicant: Adobe Systems Incorporated, San Jose, CA (US)

(72) Inventors: Dominik Suess, Brandenburg (DE); Lars Trieloff, San Francisco, CA (US); Jaemi C. Bremner, Berkeley, CA (US)

(73) Assignee: Adobe Systems Incorporated, San Jose, CA (US)

(21) Appl. No.: 14/216,259

(22) Filed: Mar. 17, 2014

(51) Int. Cl. G06Q 30/02

(52) U.S. Cl. CPC G06Q 30/0276

(57) ABSTRACT

Marketing strategy lifecycle management techniques are described. In one or more implementations, a marketing strategy is created and managed using a plurality of entities as part of a lifecycle management system. The system may include a hierarchical structure that describes a relationship of portions of the strategy to each other, such as brand, portfolio, marketing campaign, marketing channel, and marketing activity. In this way, users may view and implement different portions of the strategy through interaction at different levels within the hierarchical structure. Further, access to and implementation of metadata as part of these entities may be managed through use of states and transitions between the states and thus may control which metadata is available to users and business logic that interact with the system.

### BACKGROUND

Marketing campaigns may be utilized as part of a marketing strategy to expose the availability of products and services and well as encourage use of the product and services, such as to make consumers aware of product features and so on. The complexity of these marketing campaigns and overall marketing strategies has continued to increase, which follows an increase in the ways in which users communicate, e.g., from mail and telephone to instant messaging, social media, and email.

However, conventional techniques that are utilized to plan, execute, and/or monitor marketing campaigns are often limited to that campaign itself and thus did not address other campaigns that were part of an overall marketing strategy. Additionally, conventional techniques often followed an object model that was inflexible by limiting metadata by an implicit assumption that defined what metadata is to be included as a part of each entity. Further, conventional techniques that involved synchronization of entities due to metadata changes could also be inflexible and cause errors. Accordingly, conventional techniques that are utilized to manage a marketing campaign could be frustrating to users and even cause the users to forgo use of this functionality.

### SUMMARY

Marketing strategy lifecycle management techniques are described. In one or more implementations, a marketing strategy is created and managed using a plurality of entities as part of a lifecycle management system. The system may include a hierarchical structure that describes a relationship of portions of the strategy to each other, such as brand, portfolio, marketing campaign, marketing channel, and marketing activity. In this way, users may view and implement different portions of the strategy through interaction at different levels within the hierarchical structure. Further, access to and implementation of metadata as part of these entities may be managed through use of states and transitions between the states and thus may control which metadata is available to users and business logic that interact with the system.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIG. 2 depicts an example implementation in which marketing entities are arranged according to a hierarchy to define a marketing strategy.

FIG. 3 depicts an example implementation in which examples of marketing entities and corresponding metadata are defined and arranged according to a hierarchy.

FIG. 4 depicts a system in an example implementation of a lifecycle management for metadata of a marketing campaign that defines states for metadata entities that control the behavior of the entities in terms of permissions, versioning, persistence, and visibility within the system.

FIG. 5 is a flow diagram depicting a procedure in an example implementation in which a plurality of states are utilized to manage metadata and entities involved in a marketing strategy.

FIG. 6 is a flow diagram depicting a procedure in an example implementation in which an explicit specification of metadata is associated with entities as part of a marketing strategy that is monitored via tracking codes to describe implementation and usage of the marketing strategy.

FIG. 7 is a flow diagram depicting a procedure in an example implementation in which a system is employed to perform lifecycle management of metadata and associated values of entities as part of a marketing strategy.

FIG. 8 illustrates an example system including various components of an example device that can be implemented as any type of computing device as described and/or utilize with reference to FIGS. 1-7 to implement embodiments of the techniques described herein.

### DETAILED DESCRIPTION

### Overview

The complexity of marketing campaigns involved in overall marketing strategies is ever increasing. However, conventional techniques that are utilized to plan, execute, and monitor campaign strategies are inflexible, campaign centric (and thus did not address other marketing campaigns), are tied to specific objects and metadata associated with those objects, and so on.

Accordingly, marketing strategy lifecycle management techniques are described. In one or more implementations, entities in a marketing strategy may be planned, executed, and monitored through use of a hierarchy. For example, a marketing strategy may include entities that are positioned in different levels of the hierarchy that correspond to a brand, portfolio, marketing campaign, marketing channel, marketing activities, and so on. For example, a brand “sports&stuff.com” may include a “camping and hiking” portfolio having “cyber Monday” and “spring clearance” marketing campaigns. The marketing campaigns may also have associated marketing channels (e.g., physical and Internet) as well as marketing activities associated with those channels, e.g., printed fliers, banner ads, and so on. Thus, the entities may be utilized describe an overall marketing strategy and relationships between portions of the strategy.

Metadata may also be associated with the entities in the market strategy that describe characteristics of the respective entities. For a banner ad marketing activity, for instance, metadata may be specified that relates to views of the banner add and a value may be obtained that describes a number of the views. At a next level of a hierarchy, metadata may be specified for an entity that aggregates metadata from child entities, such as metadata for a marketing channel “online” that aggregates banner ad and email marketing activities. Thus, the hierarchical structure may be used to specify and view an effect of a marketing strategy and different levels of granularity. The entity may also include metadata of its own that is not dependent on child entities. Further, specification of metadata for these entities may be performed “on the fly” through explicit specification by a user and thus may overcome challenges of conventional object based techniques that relied on implicit specification as further described below.

Additionally, changes may be made to the marketing strategy as time passes, which may include addition of entities as well as changes to metadata associated with the entities. To manage access to the entities during these changes, states and transitions between states may be utilized to control access and visibility of the metadata and associated values. The states, for instance, may involve preparation, live, in change, archived, and so on and may be specified for entities to manage the entity and metadata associated with the entity. Additionally, each of these states may be defined in terms of permissions, versioning, persistence, or visibility. Transitions may also be defined to manage transfer from one of these states to another. The states and transitions between the states may be utilized to manage creation, execution, and monitoring of metadata as well as synchronization of changes to the metadata, such as for exposure to a browser, external business logic, and so on. Further discussion of these and other techniques involving states and transitions for entities and associated metadata may also be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

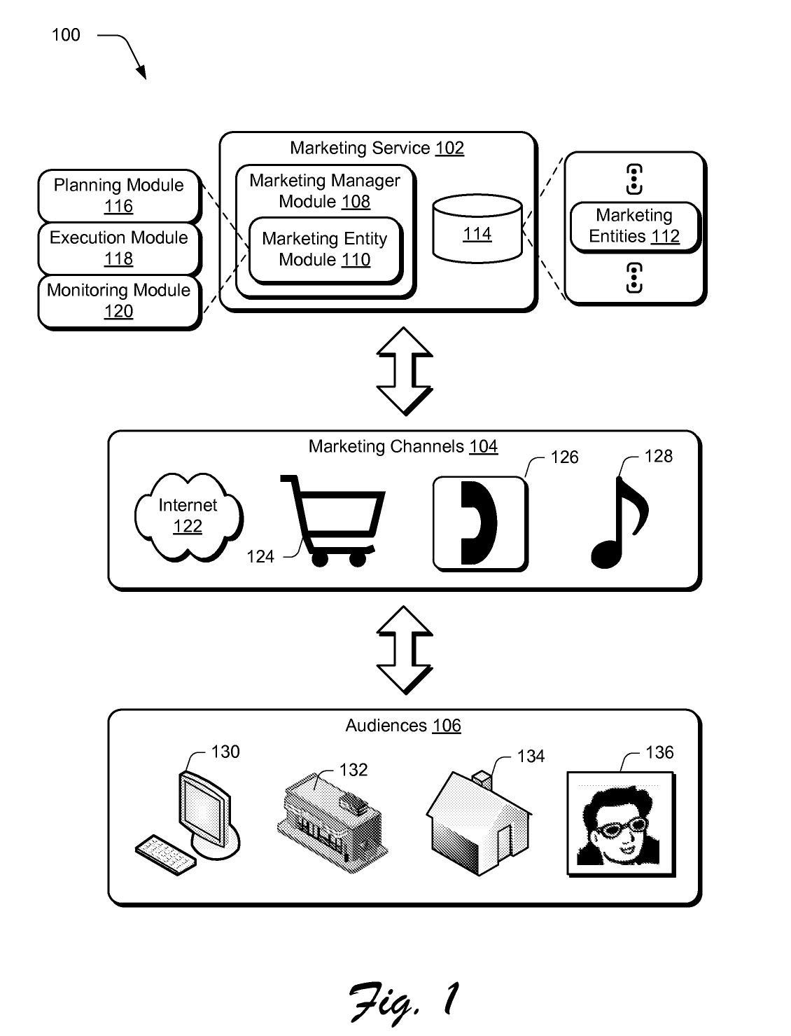

FIG. 1 is an illustration of an environment 100 in an example implementation that is operable to employ techniques described herein. The illustrated environment 100 includes a marketing service 102, marketing channels 104, and an audience 106, the functionality of which may be implemented in a variety of ways.

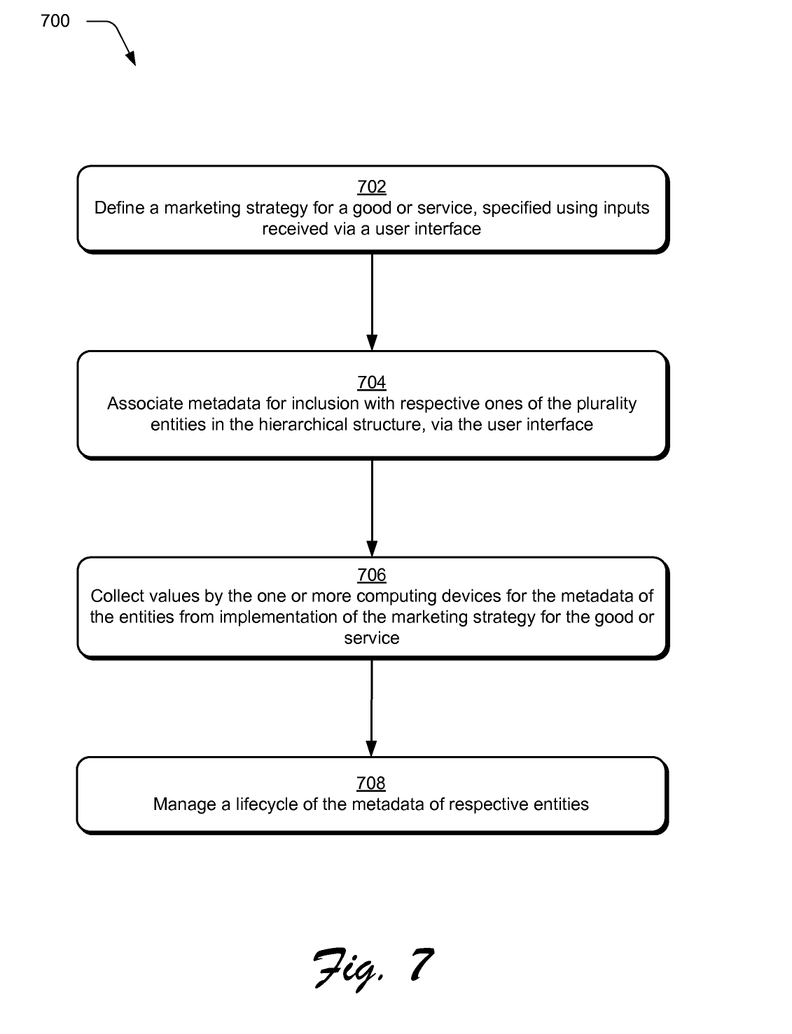

For example, the marketing service 102, marketing channels 104, and audience 106 may be implemented, in whole or in part, through use of one or more computing devices. A computing device, for instance, may be configured as a desktop computer, a laptop computer, a mobile device (e.g., assuming a handheld configuration such as a tablet or mobile phone), and so forth. Thus, a computing device may range from full resource devices with substantial memory and processor resources (e.g., personal computers, game consoles) to a low-resource device with limited memory and/or processing resources (e.g., mobile devices). Additionally, a computing device may be representative of a plurality of different devices, such as multiple servers utilized by a business to perform operations “over the cloud” as further described in relation to FIG. 7.

The marketing service 102 is illustrated as including a marketing manager module 108, which may be implemented locally and/or “over the cloud” as shown in FIG. 7. The marketing manager module 108 is representative of functionality relating to marketing strategies. For example, marketing strategies may be utilized to increase awareness of a good or service. This may include making audiences 106 aware of the good or service as well as making the audiences 106 aware of characteristics of the good or service, even if the audience 106 already owns the good. An advertiser, for instance, may form a marketing strategy to communicate functionality available from the product or service to increase usage and customer satisfaction.

Accordingly, a variety of different types of marketing strategies may be implemented by the marketing manager module 108. Furthermore, these marketing strategies may be implemented in a variety of ways. Conventional techniques to plan, track, and implement marketing, however, are inflexible and object specific as previously described. Accordingly, the marketing manager module 108 may include functionality of a marketing entity module 110 which may define a marketing strategy in the form of marketing entities 112, which are illustrated as stored in storage 114 of the marketing service 102.

The marketing entity module 110, for instance, may employ a planning module 116 that may be utilized to define a marketing strategy through the use of marketing entities 112. An execution module 118 may also be included which is representative of functionality to execute the planned marketing strategy. The marketing entity module 110 may also include functionality of a monitoring module 120 that is representative to monitor the execution of the marketing strategy, which may be utilized to describe an effectiveness of the marketing strategy.

As illustrated in FIG. 1, for instance, a plurality of different marketing channels 104 may be employed as part of a marketing strategy. Examples of different marketing channels include the internet 122 (e.g., via email, instant message, social network), physical material 124 (e.g., coupons, printed advertisements), telephonic 126, broadcasting 128 (e.g., commercials or commentary via radio, television, video), and so on. Accordingly, audiences 106 may interact with these different marketing channels 104 in a variety of different ways, such as using a computing device 130, at a physical location 132, via telephone at a user's home 134, a user 136 listening to or viewing the broadcasted 128 marketing channel.

The marketing entities 112 and associated metadata may be utilized by the marketing entity module 110 to represent these various portions of the marketing strategy described above and therefore may support a flexible and complete representation of the marketing strategy as well as to help implement and monitor this strategy. An example of use of marketing entities 112 to represent a marketing strategy is described as follows and shown in a corresponding figure.

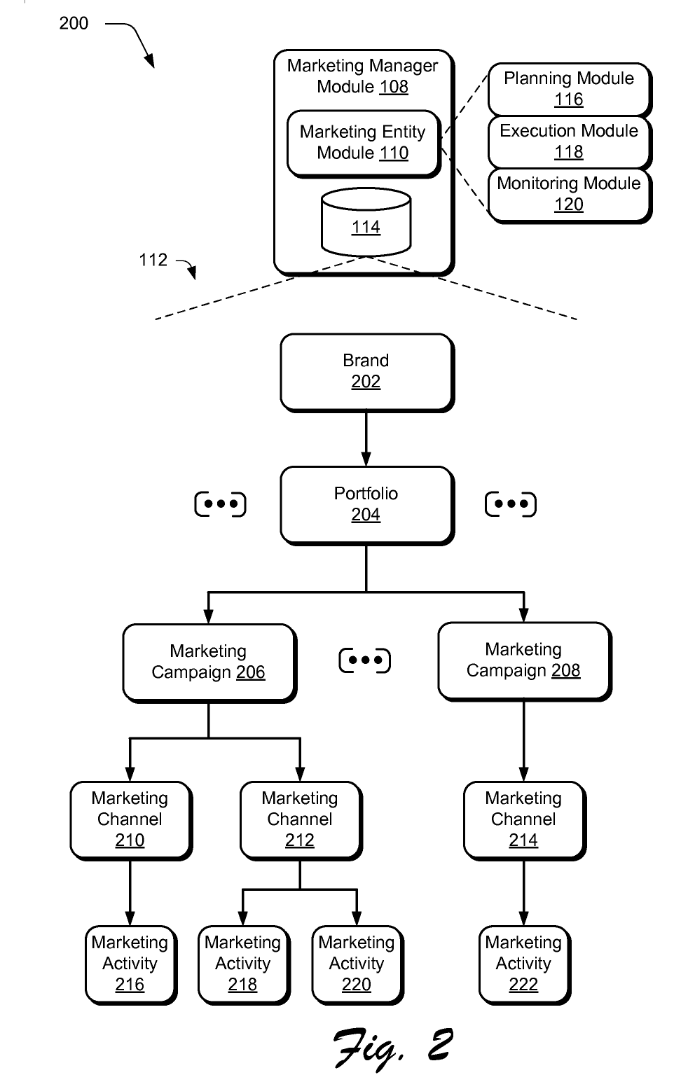

FIG. 2 depicts an example implementation 200 in which marketing entities are arranged according to a hierarchy to define a marketing strategy. The marketing strategy in this example includes hierarchical levels that include brand, portfolio, marketing campaign, marketing channel, and marketing activity in this example although additional hierarchical levels are also contemplated. Each of these levels is listed as having corresponding entities having associated metadata, e.g., brand 202, portfolio 204, marketing campaign 206, 208, marketing channel 210, 212, 214, and marketing activity 216, 218, 220, 222. Campaigns may be organized by brand, ownership, time, or marketing channels. Further, at each level, a team may defined that includes different permissions as follows:
Owners: can edit, change budget, approve and add and remove team members;
Member: can add, modify and delete at this level and lower levels; and
Observer: can read at this level and at lower levels.

Marketing campaigns determine what marketing content (also referred to as content in the follow) will be displayed to whom (e.g., audiences 106) at where (e.g., marketing channels 104) and when. Marketing campaigns typically have a specific goal that may be tracked through metrics by the monitoring module 120 of the marketing entity module 110. The execution of a marketing campaign by the execution module 118 of the marketing entity module 110 involves matching a visitor's context with the rules set in the campaign and delivery of content according to the technical constraints of the visitor's marketing channel 104.

As illustrated in FIG. 2, marketing campaigns 206, 208 are part of a portfolio 204, which may be considered a macro-level campaign. The marketing campaigns 206, 208 include one or more marketing channels 210, 212, 214, respectively. Further, each of the marketing channels 210-214 may include one or more marketing activities 216-222, respectively, which may describe tactics involved in those activities. Each of the entities may include metadata that describes properties associated with the marketing strategy at that level.

Metadata (e.g., properties) as each level may be defined as part of the campaign plan and configured to be editable via a user interface. The metadata may be measurable and importable from interaction data, e.g., through the use of tracking codes by the monitoring module 120. Further, properties may be “rolled up” such that lower level definitions or measurements may be aggregated for use by higher level entities in the hierarchy. Example of properties and subsequent roll up may be found in the following table.

| | Macro- | | Channel- | |
|---|---|---|---|---|
| | Level | Campaign- | Level | Micro-Level |
| Property | (Portfolio) | Level | (Channel) | (Activities) |
| Who | described | select | refined or | refined or |
| (Audiences) | | audience | extended | extended |
| What | none | described | defined | refined |
| (Content) | | | | |
| Where | none | select | select | select |
| (Locations) | | channels | Properties and | Locations |
| | | | Locations | |
| When | defined | refined | refined | refined |
| (Schedule) | | | | |
| Milestones | described | defined | refined | refined |
| Budget (Plan) | defined | allocated | allocated | allocated |
| Cost (Actual) | aggregated | aggregated | aggregated | measured |
| Success | aggregated | aggregated | aggregated | measured |
| Metrics | | | | |
| Metadata | defined | defined | defined | defined |
| Team | defined | defined | defined | defined |
| Parent | none | Portfolio | Campaign | Channel |

Refining Audiences 106

While audiences 106 are generally selected at a campaign-level of the hierarchy, the marketing entity module 110 may be configured to support the refining of an audience definition at a marketing channel or marketing activities level. Accordingly, operations may be added to the entities at this level such as:
restrict: by adding a targeting rule (combined with AND);
expand: by adding a targeting rule (combined with OR); and
split: by adding a targeting rule that will split the audience into two groups.

Describing Content

Content and assets that are to be produced may be described in a creative brief. The creative brief may be provided by the marketing entity module 110 as a text field with text editing capabilities or by having the ability to upload attachments. Creative briefs may be made available in a digital asset management system implemented by the marketing manager module 108 as one or more documents. The creative brief, for instance, may be authorized as a document for inclusion in one or more of the entities, which may be created automatically. Changing or creating the Creative Brief may cause creation of a card.

Defining Content

Defining content for inclusion as part of an entity through interaction with the planning module 116 may cause an empty content entity to be created as part of content management, e.g., as part of a Digital Asset Management (DAM) system implemented by the marketing entity module 110. This may include use of a placeholder for a content specification, which describes the content to be created in greater detail. The content specification may be configured in a variety of ways. For example, the content specification may include simple text, include attachments such as images, and so on. The content specification may be compiled in the creative brief Changes to the content specification may also cause creation of a card.

Refining Content

Refining content involves modification to an already existing piece of content from content management. This may include use of WYSIWYG editing or cloning and editing afterwards. Changing content may cause creation of a card.

Selecting Marketing Channels

Selecting marketing channels through interaction with the planning module 116 may involve selecting one or more marketing channels from a user interface that includes a list of supported channels. In one or more implementations, the list of supported channels is in the low tens. Adding or removing a marketing channel from the Campaign may cause creation of a card. Removing a marketing channel from the marketing campaign may cause it to be moved to a deactivated marketing channels list, if there are locations in the marketing campaign for that marketing channel.

Selecting Properties

For a given channel, the planning module 116 may output a user interface via which a user may select properties that are available. The list of properties for a marketing channel can be up to multiple hundreds, for instance for landing pages in an Internet example. Additionally, marketing channels may support “on-the-fly” creation of new properties. Selecting a property may cause creation of a card.

Selecting Locations

For a given property, a location may be specified through interaction with a user interface of the planning module 116. Additionally, locations may be selected that are not part of properties that have been selected prior, e.g., in this case the containing property is added as well. Selecting a location may cause creation of a card.

Defining Schedules

The planning module 116 may support definition of a schedule for a portfolio 204 that supports selection of a start date (e.g., year and month, day is optional) and an end date (e.g., year and month, day is optional). If no end date is selected, the portfolio 204 may be considered to run indefinitely.

The portfolio schedule may be configured a soft schedule, such that it will not deactivate marketing campaigns 206, 208 outside of the scheduled dates, but will warn the portfolio 204 creator and the marketing campaign 206, 208 creator that a conflict has been detected. Selection of the portfolio 204 may cause an overview to be displayed in a user interface of each of the marketing campaigns 206, 208 scheduled in it. Changing a portfolio schedule may cause creation of a card, and so too may a change to a beginning or end of a portfolio 204.

Defining Marketing Campaign 206, 208 Schedules

The planning module 116 may output a user interface configured to accept inputs to specify a schedule for a marketing campaign 206, 208, e.g., selection of a start date (e.g., year, month, day), an optional end date (e.g., year, month, day), and so on. If an end date is not selected, for instance, the marketing campaign 206, 208 may be configured to run indefinitely. In one or more implementations, if a schedule of the marketing campaign 206, 208 overruns scheduling boundaries of a portfolio 204, in which, it is contained a warning may be output by the planning module 116 for viewing by a campaign manager and/or a creator of marketing campaign 206, 208.

If marketing activities 216-220 in the marketing campaign 206 violate schedule boundaries of the containing marketing campaign 206, the marketing activity 216-220 may be deactivated and a warning given by the planning module 116 to the marketing activity 216-222 creator and/or the marketing campaign 206 creator. Selection of the marketing campaign 206 in this example may cause output in a user interface showing an aggregate of marketing campaign activity per marketing channel 210, 212 over time. Changing a marketing campaign 206 schedule as well as start and end date of a marketing campaign 206 schedule may trigger creation of a card.

Refining Marketing Channel Schedules

Definition of a marketing channel 210-214 schedule allows the definition of a start date (e.g., year, month, day) and end date (e.g., year, month, day) through interaction with a user interface of the planning module 116. If a start or end date is not provided, the planning module 116 may use the start and end day of the containing marketing campaign 206, 208.

The planning module 116 may be configured such that a marketing channel 206, 208 schedule does not exceed the containing marketing campaign 206, 208 schedule. In one or more implementations, marketing channel schedules 210-214 are configured as soft schedules, such that violations are reported by the planning module 118 to the owner of the containing marketing campaign and the contained marketing activity entities. Changing a channel schedule as well as a start or end date of a marketing channel schedule may trigger creation of a card.

Refining Activity Schedules

Marketing activity schedules 216-222 include a start date (if none is provided, the respective marketing campaign start date may be used by the planning module 116) and may have an end date, e.g., if none is provided, the marketing campaign end date may be used. Some activities, for instance Social Media content delivery may not have an end date as these activities involve singular events. Marketing activity schedules may have a granularity down to the minute. Changing an activity schedule as well as start and end of a marketing activity schedule may cause creation of a card.

Describing Milestones

Description of milestones at a portfolio 204 level through output of a user interface by the planning module 116 may involve providing a milestone title and a milestone description. A date for the milestone may be defined with a year, month, and have day granularity. Description of a portfolio milestone may cause creation of a card.

Defining Milestones

Definition of a milestone at the marketing campaign 206-208 level may involve setting either a lower bound or upper bound for the value for the marketing campaign's 206, 208 key success metric. In one or more implementations, campaign milestones are limited to campaign-wide metrics although other implementations are also contemplated. For each portfolio or marketing campaign milestone, values may be provided via the planning module 116 user interface. The marketing entity module 118 may interpolate a growth line between two milestones and output a warning in a user interface if milestone targets are outside of a predicted value for the success metric.

Modification of a campaign milestone as well as hitting a campaign milestone may trigger creation of a card. Hitting the lower or upper bound of the target metric early may also cause creation of a card and updated predictions that the target metric cannot be met may also cause create a card.

Refining Milestones

Milestones may also be refined at the marketing channel and marketing activity level in the hierarchy by adding channel-specific target metrics with an upper and lower bound. The planning module 116 may also support creation of new marketing channel or marketing activity specific milestones, however these may affect channel-specific metrics, not campaign specific metrics in this example.

Modification of a marketing channel or marketing activity milestone as well as hitting a marketing channel or marketing activity milestone may trigger creation of a card. Additionally, hitting the lower or upper bound of the target metric early may also card creation. Further, updated predictions that the target metric cannot be met may cause creation of a card.

Defining Budget

Portfolio 204 budgets may be defined in a number value and currency through interaction with a user interface of the planning module 116. The currency may apply to each of the marketing campaigns 206, 208 in the portfolio 204 and thus follow a hierarchical relationship. For portfolios that are time limited, the budget may be applied to an entire marketing campaign run time. For indefinite portfolios, the budget may be specified per month, with detailed monthly splits applied at a later time. At the portfolio 204 level, a user (e.g., portfolio manager) may allocate a split of the budget to each contained marketing campaign 206, 208. The portfolio manager, for instance, may view the following in a marketing entity module 110 user interface:
complete budget;
allocated budget (per campaign);
requested budget (per campaign); and
spent budget (is not re-allocated).

Allocating Marketing Campaign Budget

Users (e.g., marketing campaign managers in this example) may request a budget and receive a warning if the requested budget is higher than a current allocation. Additionally, a split may be assigned to each contained marketing channel 210, 212, 214. The marketing campaign manager, for instance, may view the following in a marketing entity module 110 user interface:
complete (granted) budget;
allocated budget (per channel);
requested budget (per channel); and
spent budget (is not re-allocated).

Allocating Marketing Channel Budget

Users (e.g., marketing channel managers in this example) may request a budget and receive a warning if the requested budget is higher than the current allocation. Additionally, a split may be assigned to each contained marketing activity.

The marketing channel manager, for instance, may view the following in a marketing entity module 110 user interface:
complete (granted) budget;
allocated budget (per activity); and
spent budget (is not re-allocated).

Allocating Activity Budget

A marketing activity budget may be allocated in a variety of ways. For example, a reserved budget may be allocated such that the budget cannot be spent by other competing marketing activities. A maximum budget may also be allocated in which a maximum amount of money is specified that may be spent on this marketing activity, e.g., which may also be at the expense of other marketing activities. In another example, a maximum bid may be allocated to define a maximum budget for a single impression.

Measuring and Aggregating Cost

Cost may be represented using the smallest cost-incurring unit, for instance a single display ad impression. Additionally, cost may be aggregated from level to level. A split may be viewed in a user interface for each level of cost one level below and the top items from two levels below.

Measuring Metrics

Metrics may be measured at a smallest unit of engagement, e.g. at the marketing activity. Additionally, each marketing channel may have its own kind of metrics like order value, conversion rate, and so forth.

Aggregating Marketing Channel, Marketing Campaign, and Portfolio Metrics

Within a marketing channel, each of the metrics may be aggregated. For example, some metrics may be aggregated as sum, an average, median value, number of values, number of distinct values, and so on. Metrics that work across marketing channels may also be used as marketing campaign metrics and may be used as marketing campaign goals. Metrics that cannot be aggregated across marketing channels may be ignored in the marketing campaign level. The portfolio aggregation may concentrate on high-level metrics such as goal completion, budget/cost ratio, audience size, and so on.

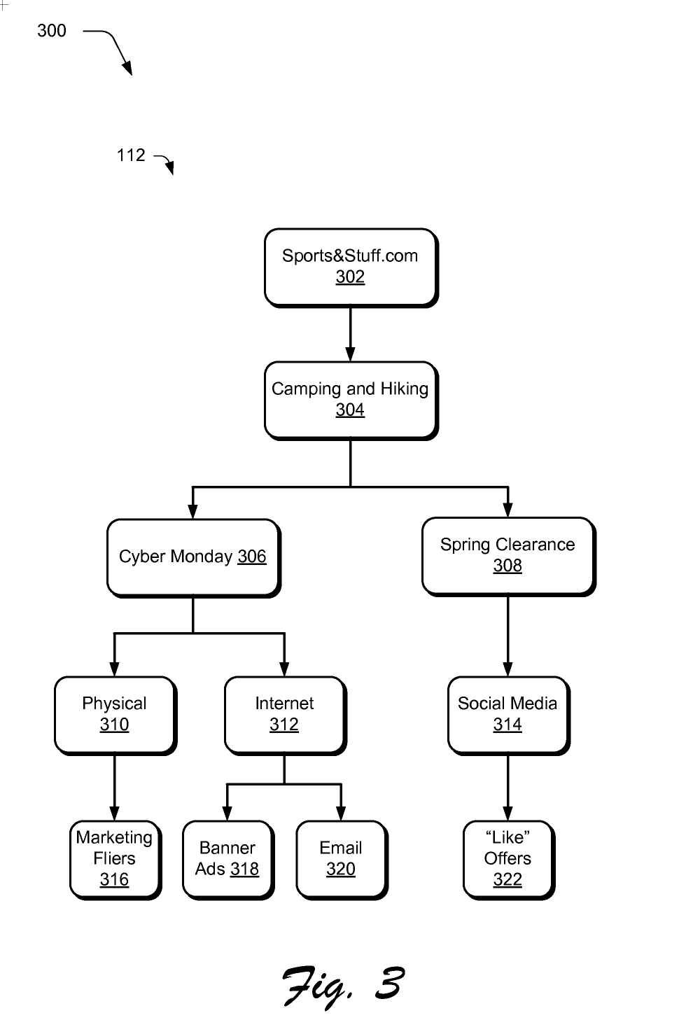

FIG. 3 depicts an example implementation 300 in which marketing entities are defined and arranged according to a hierarchy. In this example, a marketing strategy is specified through interaction with a user interface output by a planning module 116 of FIG. 1, execution and monitoring of which may be performed through user interfaces output by the execution and monitoring modules 118, 120, respectively, of the marketing entity module 110. Entities and associated metadata are arranged accordingly to a hierarchy as described in relation to FIG. 2 that includes a brand, portfolio, marketing campaign, marketing channel, and marketing activity levels.

As illustrated, for instance, a brand is represented as an entity “sports&stuff.com” 302 and may include metadata describing the brand. A portfolio is contained within that brand which is represented by a “camping and hiking” 304 element and associated metadata, e.g., describing products and services contained within that portfolio for that brand. The portfolio “camping and hiking” 304 includes marketing campaigns that are represented as two active entities in this example, which include Cyber Monday 306 and Spring Clearance 308.

Additionally, the marketing campaigns may include respective marketing channels represented by the entities physical 310, Internet 312, and Social Media 314. Marketing activities that are contained within these marketing channels are represented as marketing fliers 316, banner ads 318, email 320, and “Like” offers 322. Thus, each of these entities may represent a part of an overall marketing strategy for a brand which may be accessed by corresponding users having defined roles as previously described.

Further, each of these entities may be automatically assigned a tracking number to aid in the planning, execution, and monitoring of the entities. For example, individual entities such as marketing activities as well as marketing channels, marketing campaigns, portfolios, and brands may be assigned tracking numbers. These tracking numbers may be utilized to evaluate performance of the respective entities and thus may aid a user in determining how and where to allocate marketing resources. A variety of other examples are also contemplated without departing from the spirit and scope thereof.

Metadata may be associated with the entities in a variety of ways. For example, the entities may include implicit metadata properties that are automatically included with the entity, such as to define a type for a marketing channel. The entities may also support explicit specification of properties by the marketing entity module 110. For example, a user interface may be output that is configured to receive one or more inputs that specify a type of metadata (e.g., property) that is to be included with an entity as well as data involving that type, e.g., criteria employed for a “Like” offer 322 marketing activity that is contained by a social media 314 marketing channel. In this way, different properties and data may be specified for individual entities and thus support increased flexibility as opposed to conventional type-based techniques in which each object included matching properties.

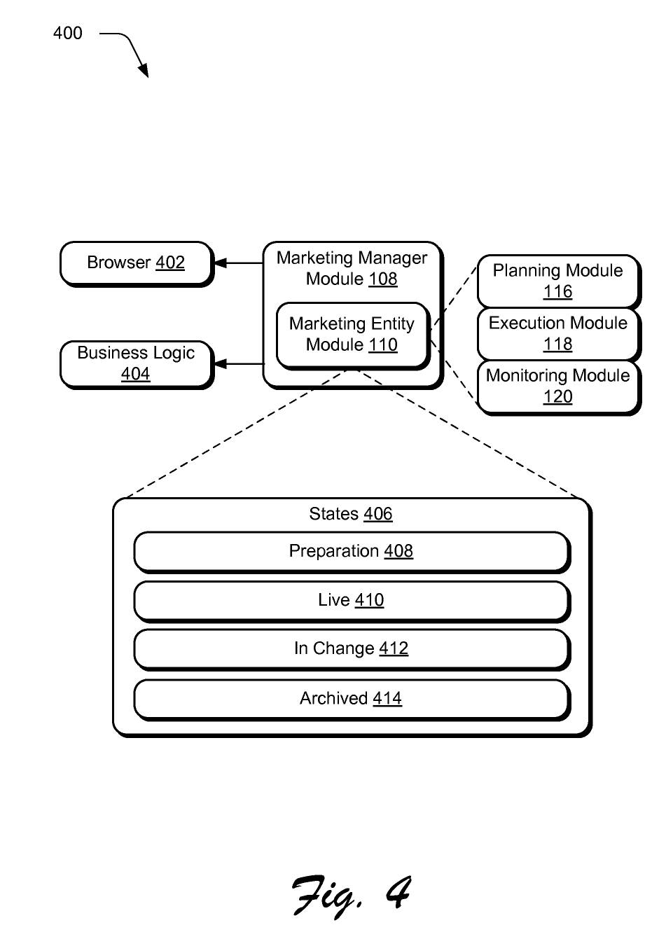

FIG. 4 depicts a system 400 in an example implementation of lifecycle management for metadata of a marketing campaign that defines states for metadata entities that control the behavior of the entities in terms of permissions, versioning, persistence and visibility within the system. When implementing a system managing metadata for campaigns the optimal behavior of the entities containing the metadata may change over time. While some changes might not be problematic before the data has been synchronized to third party systems (e.g., a browser 402 or business logic 404 implemented external to the system) for the first time such changes may be restricted after such synchronization. The requirements for the behavior of these entities may be split in multiple states with transitions that define the conditions for such a change as follows.

A platform, for instance, may be leveraged by the marketing entity module 110 that defines various states 206 of entities containing campaign metadata and corresponding transitions between those states. In this way, an optimal user experience may be ensured with a reduced complexity of business logic. A variety of different states may be utilized to define the behavior, examples of which follow.

A preparation 408 state, for instance, may be configured to provide permissions such that read and write access is defined by a user's role as described above. A version is not created until a state changes. For persistence, values of metadata may be dynamic and may depend on external data such as configuration or inherited values. The preparation 408 state may also specify visibility considerations such that the metadata is visible via a browser 402 but is not visible to further business logic 406 such as exports. Further, changes to this data when in a preparation 408 state do not trigger exports. Additional actions like move and delete are available that are not available to any other of the states 406 due to referential constraints like already exported data. A transition from the preparation 408 state to a “live” state is permitted.

A live 410 permission state may be configured to provide permissions such that read only access is granted solely when in this state. As the name implies, the live 410 state may follow a transition from the preparation 408 state and reflects that metadata is available for active use. Versioning information is created upon a transition to the live 410 state from other states, e.g., from a preparation 408 state. In regards to persistence, values of metadata may be dynamic and dependent on external data like configuration or inherited values. When in a live 410 state, metadata is visible to browser 402 and other business logic 404, e.g., changing to this state may trigger further business logic 404 such as export and the metadata is visible in exports. A transition from the live 410 state to an in change state 412 or archived 414 state is permitted.

An in change 412 state may be configured to provide permission such that read and write access are defined by a user's role. For versioning, if an unstable head is encountered by logic that depends on stage data a lookup may be performed for a version that is created for a previous live 410 state. For persistence, values of metadata may be dynamic and dependent on external data like configuration or inherited values. When in an in change 410 state, metadata is visible to browser 402 as well as business logic 404, and if the business logic is dependent on stable data a previous stable version of the live 410 state for the metadata may be used. In this way, changes may be made to the metadata without affecting other business logic that leverages the metadata. A transition from the in change 412 state to the live 410 state is permitted.

An archived 414 state may be configured to grant permissions that involve read only access for any user and restrict changes of values of metadata when in this state. As far as version, this is the final state and so the entity is the final version. Regarding persistence, dynamic metadata that is dependent on configuration of inheritance is frozen such that resulting values are persisted and do not change upon configuration changes or changes of values of ancestors to this metadata. For visibility, metadata in an archived 414 is not visible as part of default browsing of a browser 402 or via business logic 404, however specific archived 414 state interfaces may be employed to search for archived entities. A transition from the archived 414 state to a live 410 state is permitted, e.g., reverting an accidental archival of an entity restores a previous (e.g., stable live 410 version) of the entity.

The above states and transitions between the states may be utilized to support a variety of functionality. For example, these states and transitions may act as constraints on removal or move actions that are applied when user completes preparation, such that users may change and revert their actions without consequences to entities and associated metadata. Additionally, the live 410 state supports a stable state that may be used for versioning and may be viewed at any time thereafter. The in change 412 state supports user controlled changes to data that is already exported, thereby providing a transition to an intermediate unstable state. The archived 414 state allows a user to keep the management user interface clean of obsolete data. Additionally, the archived 414 state allows a reduction in the amount of data to be handled by further business logic 404 like exports and thereby avoid an endless growth of data involved in a marketing strategy. Other examples are also contemplated, further discussion of which may be found in relation to the following procedures.

Example Procedures

The following discussion describes marketing campaign management techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-4.

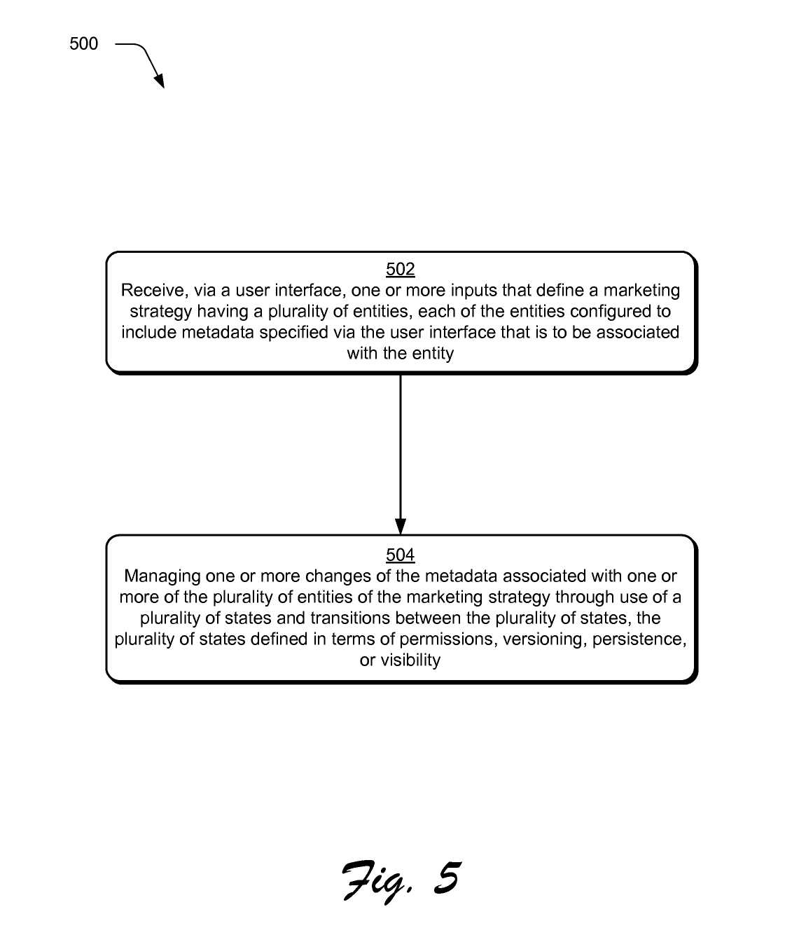

FIG. 5 depicts a procedure 500 in an example implementation in which a plurality of states are utilized to manage metadata and entities involved in a marketing strategy. One or more inputs are received, via a user interface, that define a marketing strategy having a plurality of entities, each of the entities configured to include metadata specified via the user interface that is to be associated with the entity (block 502). A user, for instance, may interact with a user interface output by a planning module 116 to specify entities, metadata associated with the entities, and relationships between the entities. For example, a user may specify a hierarchical relationship of entities as part of a marketing strategy as shown in FIG. 3.

One or more changes are managed of the metadata associated with one or more of the plurality of entities of the marketing strategy through use of a plurality of states and transitions between the plurality of states, the plurality of states defined in terms of permissions, versioning, persistence, or visibility (block 504). Continuing as part of the previous example, the entities planned as part of the planning module 116 may then be exposed for execution by the execution module 118. During the execution, changes may be made to the entities, metadata associated with the entities, and/or relationships between those entities. Accordingly, states and transitions between the states may be utilized to manage how changes are made, visibility of data, permissions, and so on as described above.

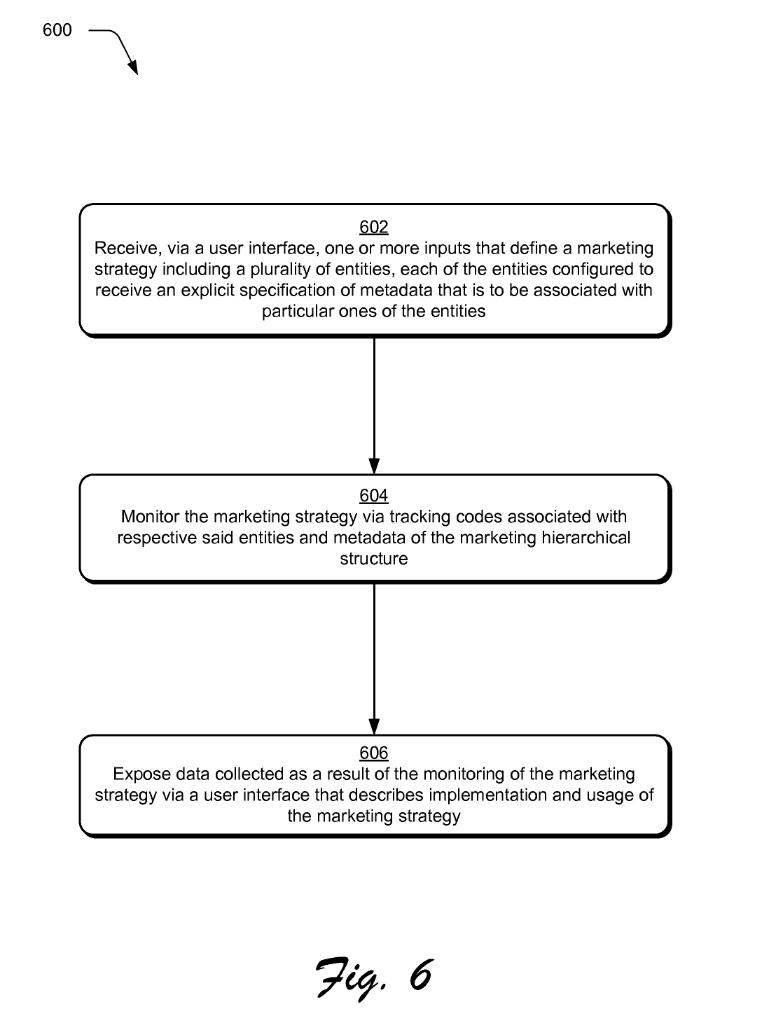

FIG. 6 depicts a procedure 600 in an example implementation in which an explicit specification of metadata is associated with entities as part of a marketing strategy that is monitored via tracking codes to describe implementation and usage of the marketing strategy. One or more inputs are received, via a user interface, that define a marketing strategy including a plurality of entities, each of the entities configured to receive an explicit specification of metadata that is to be associated with particular ones of the entities (block 602). For example, a user may interact with a user interface and define entities as part of a marketing strategy as previously described. Further, the user interface may support explicit specification of types of metadata that are to be included with the entities, e.g., properties of the entities as shown above, as well as values for those properties. Therefore, rather than being limited to implicit types of metadata that were automatically included in conventional techniques, these techniques may provide increased flexibility. For instance, a change to an object in conventional techniques caused population of that change to each of the other objects having that type. However, in this case this change may be made for individual entities of the marketing strategy.

The marketing strategy is monitored via tracking codes associated with respective entities and metadata of the marketing hierarchical structure (block 604). Continuing with the previous example, the panning module 116 may automatically incorporate tracking codes as part of the entities as well as for metadata included in the entities. The monitoring module 120 may then use these tracking codes to track implementation and usage of entities of the marketing strategy, such as for marketing activities, marketing channels, and so on.

Data that is collected as a result of the monitoring of the marketing strategy is exposed via a user interface that describes implementation and usage of the marketing strategy (block 606). The user interface, for instance, may be output by the monitoring module 120 to describe as result of the monitoring. In this way, changes may be made to the marketing strategy by a user as desired, such as to make changes to budgets, put greater emphasis on particular activities, marketing channels, and so on. A variety of other examples are also contemplated as previously described.

FIG. 7 depicts a procedure 700 in an example implementation in which a system is employed to perform lifecycle management of metadata and associated values of entities as part of a marketing strategy. A marketing strategy for a good or service is specified using inputs received via a user interface (block 702). The marketing strategy is defined as a hierarchical structure having a plurality of entities arranged in corresponding levels within the hierarchical structure to describe an association of marketing activities with respective marketing channels and the respective marketing channels with respective ones of a plurality of marketing campaigns for the marketing strategy.

Metadata is associated for inclusion with respective ones of the plurality entities in the hierarchical structure via the user interface (block 704). The metadata defines characteristics of the respective entities in relation to the marketing strategy, the metadata assigned corresponding tracking codes automatically and without user intervention by the one or more computing devices.

Values are collected by the one or more computing devices for the metadata of the entities from implementation of the marketing strategy for the good or service (block 706). The values, for instance, may be collected using the tracking codes from sources external to the one or more computing devices, such as received from communications from third-party systems that includes the tracking codes, e.g., for purchases, page views, use of physical fliers, coupon codes, and so on.

A lifecycle of the metadata of respective entities is managed (block 708). This management may be performed through use of states and transitions between the states that involve permissions that define which users are permitted to change the metadata, versioning for the changes made to the metadata, and visibility to control access to the metadata and corresponding values by the users or business logic. The business logic, for instance, may access the system through one or more SPIs and used to automatically perform analysis of the efficacy of various portions of the marketing strategy by leveraging the hierarchical structure.

Example System and Device

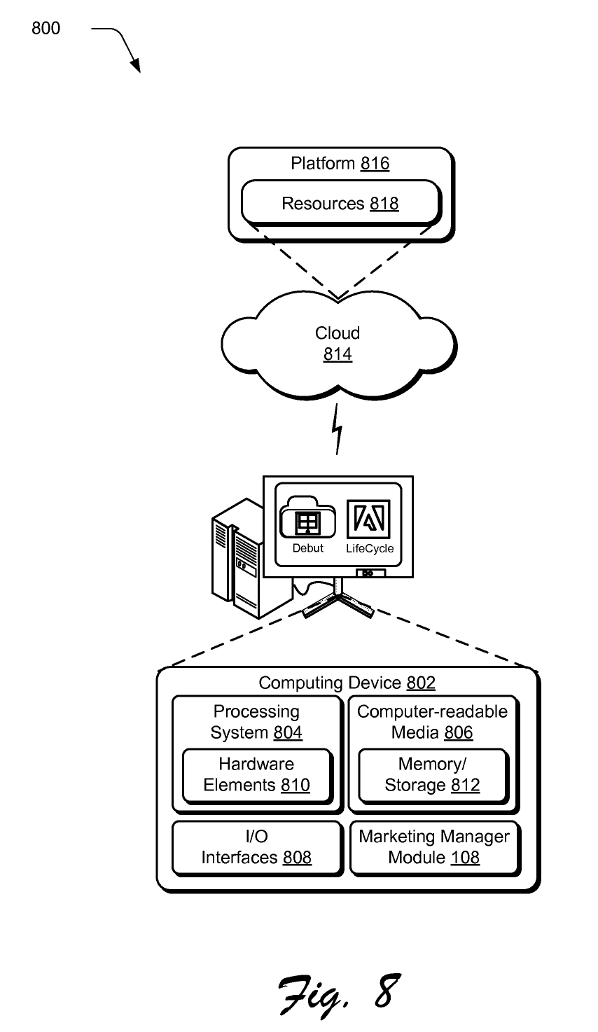

FIG. 8 illustrates an example system generally at 800 that includes an example computing device 802 that is representative of one or more computing systems and/or devices that may implement the various techniques described herein. This is illustrated through inclusion of the marketing manager module 108. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

The techniques described herein may be supported by various configurations of the computing device 802 and are not limited to the specific examples of the techniques described herein. This functionality may also be implemented all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 may include applications and/or data that can be utilized while computer processing is executed on servers that are remote from the computing device 802. Resources 818 can also include services provided over the Internet and/or through a subscriber network, such as a cellular or Wi-Fi network.

The platform 816 may abstract resources and functions to connect the computing device 802 with other computing devices. The platform 816 may also serve to abstract scaling of resources to provide a corresponding level of scale to encountered demand for the resources 818 that are implemented via the platform 816. Accordingly, in an interconnected device embodiment, implementation of functionality described herein may be distributed throughout the system 800. For example, the functionality may be implemented in part on the computing device 802 as well as via the platform 816 that abstracts the functionality of the cloud 814.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by one or more computing devices, the method comprising:
defining a marketing strategy for a good or service, specified using inputs received via a user interface, as a hierarchical structure having a plurality of entities arranged in corresponding levels within the hierarchical structure to describe an association of marketing activities with respective marketing channels and the respective marketing channels with respective ones of a plurality of marketing campaigns for the marketing strategy;
associating metadata for inclusion with respective ones of the plurality entities in the hierarchical structure, via the user interface, that defines characteristics of the respective entities in relation to the marketing strategy, the metadata assigned corresponding tracking codes automatically and without user intervention by the one or more computing devices;
collecting values by the one or more computing devices for the metadata of the entities from implementation of the marketing strategy for the good or service using the tracking codes from sources external to the one or more computing devices; and
managing a lifecycle of the metadata of respective said entities through use of states and transitions between the states that involve permissions that define which users are permitted to change the metadata, versioning for the changes made to the metadata, and visibility to control access to the metadata and corresponding values by the users or business logic.

2. A method as described in claim 1, wherein the associating is performable for single entities within a corresponding level within the hierarchical structure such that the metadata associated for one of the entities is not associated for another one of the entities.

3. A method as described in claim 1, wherein the plurality of marketing campaigns are associated with an entity in the hierarchical structure that describes a portfolio for the good or service for the marketing strategy.

4. A method as described in claim 1, wherein the plurality of marketing campaigns are associated with an entity in the hierarchical structure that describes a brand for the good or service for the marketing strategy.

5. A method as described in claim 1, wherein the plurality of marketing channels include a physical marketing channel and a network-based marketing channel.

6. A method as described in claim 1, wherein at least one of the states includes a preparation state that is defined such that the permissions grant read/write access as defined by a user's role, the version is not created until state changes, persistence is defined such that values of the metadata are configurable as dynamic and depend on external data, and the visibility is defined such that the metadata is visible to browsing.

7. A method as described in claim 6, wherein the external data includes configuration or inherited values and the visibility is defined such that the metadata is not visible for export to the business logic.

8. A method as described in claim 7, wherein the metadata is available to move and delete actions while in the preparation state, the move and delete actions not available in any other of the plurality of states.

9. A method as described in claim 1, wherein at least one of the states includes a live state, the live state is defined such that the permissions grant read only access, the version created upon a change to the live state, persistence is defined such that values of the metadata are configurable as dynamic and depend on external data, and the visibility is defined such that the metadata is visible to browsing by the users and export to the business logic.

10. A method as described in claim 1, wherein at least one of the states includes an in-change state, the in-change state is defined such that the permissions grant read/write access as defined by a role of the user, the version is defined using an unstable head, and the business logic, when dependent on stable data, is caused to look up version data created for a previous live state, persistence is defined such that values of the metadata are configurable as dynamic and depend on external data, and the visibility is defined such that the metadata is visible to browsing and exports.

11. A method as described in claim 1, wherein at least one of the states includes an archived state, the archived state is defined such that the permissions grant read only access, the version is a final version, persistence is defined such that values of the metadata that depend on data external to the one or more computing devices and dependent on configuration or inheritance is froze such that resulting values are persisted and do not change upon configuration changes or changes of values of entity ancestors, and the visibility is defined such that the metadata is not visible via browsing and export to business logic and is visible via a dedicated interface to metadata in the archived state.

12. A method implemented by one or more computing devices, the method comprising:
receiving a marketing strategy for a good or service having a hierarchical structure that includes a plurality of entities arranged in corresponding levels within the hierarchical structure to describe an association of marketing activities with respective marketing channels and the respective marketing channels with respective ones of a plurality of marketing campaigns for the marketing strategy;
monitoring the marketing strategy using external data sources to the one or more computing devices via tracking codes associated, automatically and without user intervention, with respective said entities and metadata of the hierarchical structure; and
exposing data collected as a result of the monitoring of the marketing strategy for consumption via a user interface or business logic that describes implementation and usage of the marketing strategy.

13. A method as described in claim 12, wherein association of metadata with one of the entities does not cause explicit specification of the metadata for another one of the entities at a same level within the hierarchical structure.

14. A method as described in claim 12, further comprising managing a lifecycle of the metadata of respective said entities through use of states and transitions between the states that involve permissions that define which users are permitted to change the metadata, versioning for the changes made to the metadata, and visibility to control access to the metadata and corresponding values by the users or business logic.

15. A method as described in claim 14, wherein at least one of the states includes a preparation state that is defined such that the permissions grant read/write access as defined by a user's role, the version is not created until state changes, persistence is defined such that values of the metadata are configurable as dynamic and depend on external data, and the visibility is defined such that the metadata is visible to browsing.

16. A method as described in claim 14, wherein at least one of the states includes a live state, the live state is defined such that the permissions grant read only access, the version created upon a change to the live state, persistence is defined such that values of the metadata are configurable as dynamic and depend on external data, and the visibility is defined such that the metadata is visible to browsing by the users and export to the business logic.

17. A method as described in claim 14, wherein at least one of the states includes an in-change state, the in-change state is defined such that the permissions grant read/write access as defined by a role of the user, the version is defined using an unstable head, and the business logic, when dependent on stable data, is caused to look up version data created for a previous live state, persistence is defined such that values of the metadata are configurable as dynamic and depend on external data, and the visibility is defined such that the metadata is visible to browsing and exports.

18. A method as described in claim 14, wherein at least one of the states includes an archived state, the archived state is defined such that the permissions grant read only access, the version is a final version, persistence is defined such that values of the metadata that depend on data external to the one or more computing devices and dependent on configuration or inheritance is froze such that resulting values are persisted and do not change upon configuration changes or changes of values of entity ancestors, and the visibility is defined such that the metadata is not visible via browsing and export to business logic and is visible via a dedicated interface to metadata in the archived state.

19. A system comprising:
one or more modules implemented at least partially in hardware to implement a marketing strategy, the one or more modules including:
a planning module configured to collect, via a user interface, one or more inputs that define a marketing hierarchical structure of entities that include a plurality of marketing campaigns, marketing channels associated with respective ones of the plurality of marketing campaigns, and marketing activities associated with respective ones of the marketing channels;
an execution module configured to execute the marketing campaign for the marketing channel of the marketing campaign; and
a monitoring module configured to collect and expose data from sources external to the one or more modules that describes implementation and usage of the marketing campaign, marketing channel, and marketing activity using tracking codes associated with respective said entities of the marketing hierarchical structure.

20. A system as described in claim 19, wherein the execution module is configured to manage a lifecycle of the metadata of respective said entities through use of states and transitions between the states that involve permissions that define which users are permitted to change the metadata, versioning for the changes made to the metadata, and visibility to control access to the metadata and corresponding values by the users or business logic.
